(19) United States
(12) Patent Application Publication
(10) Pub. No.: US 2025/0286421 A1
(43) Pub. Date: Sep. 11, 2025

(54) MOTOR

(71) Applicant: TOYOTA JIDOSHA KABUSHIKI KAISHA, Toyota-shi (JP)

(72) Inventors: Hiroaki EBUCHI, Hadano-shi (JP); Masashi KOBAYASHI, Susono-shi (JP)

(73) Assignee: TOYOTA JIDOSHA KABUSHIKI KAISHA, Toyota-shi (JP)

(21) Appl. No.: 18/970,645

(22) Filed: Dec. 5, 2024

(30) Foreign Application Priority Data
Mar. 5, 2024 (JP) 2024-033330

(51) Int. Cl. H02K 1/32; H02K 7/00

(52) U.S. Cl. CPC H02K 1/32; H02K 7/003

(57) ABSTRACT

The present disclosure relates to a motor. The motor is equipped with a shaft center cooling structure. The motor includes a rotor shaft that includes, on a shaft center, at least two kinds of a first coolant channel and a second coolant channel. The coolant channels are each configured separately along a rotation axis direction.

### CROSS-REFERENCE TO RELATED APPLICATION

This application claims priority to Japanese Patent Application No. 2024-033330 filed on Mar. 5, 2024, incorporated herein by reference in its entirety.

### BACKGROUND

### 1. Technical Field

The present disclosure relates to a motor.

### 2. Description of Related Art

Japanese Unexamined Patent Application Publication No. 2022-30847 (JP 2022-30847 A) describes technology of a rotating electric machine including a rotor having a hollow rotor shaft and a rotor core, a stator having a stator core and a coil, and a case member housing the rotor and the stator, in which a coolant path for cooling outside of the stator with coolant is formed. In this technology, an oil channel structure for supplying oil, such as automatic transmission fluid (ATF) or the like, discharged by an oil pump, is provided inside the hollow of the rotor shaft, and heat-exchange is performed between the coolant flowing in the coolant path of the case member, and the oil discharged by the oil pump. This ensures cooling performance for the rotating electric machine.

### SUMMARY

However, in JP 2022-30847 A, the inside of the rotor is cooled by an oil path of one type of oil, and thus the cooling performance regarding the rotor is becomes lower when the oil is at high temperatures, and also heat exchange between the oil and the coolant is performed at another place outside the rotor, and accordingly there is room for improvement.

The present disclosure provides a motor capable of maintaining cooling performance.

A motor according to the present disclosure is equipped with a shaft center cooling structure, the motor including a rotor shaft that includes, on a shaft center, at least two kinds of coolant channels that are each configured separately along a rotation axis direction.

The present disclosure provides an effect that cooling performance can be improved.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a cross-sectional view showing a schematic configuration of a motor according to an embodiment; and

FIG. 2 is a cross-sectional arrow view of the rotor and rotor shaft taken along A-A of FIG. 1.

### DETAILED DESCRIPTION OF EMBODIMENTS

Hereinafter, a motor according to an embodiment of the present disclosure will be described with reference to the drawings. The constituent elements in the following embodiments include those that can be easily replaced by a person skilled in the art or those that are substantially the same. In addition, the drawings referred to in the following description only schematically show shapes, sizes, and positional relationships to the extent that the contents of the present disclosure can be understood. That is, the present disclosure is not limited to only the shapes, sizes, and positional relationships illustrated in the drawings.

### Motor Configuration

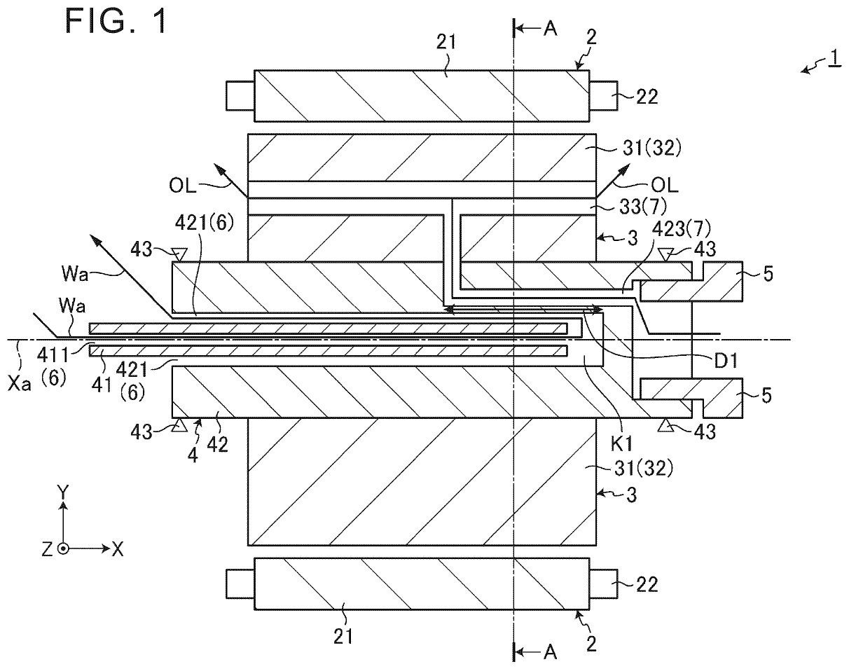

FIG. 1 is a cross-sectional view illustrating a schematic configuration of a motor according to an embodiment. The motor 1 shown in FIG. 1 is mounted on a vehicle, for example, and is rotationally driven by a current supplied from the outside, for example, a three-phase alternating current. The motor 1 includes a substantially cylindrical stator 2 fixed to a frame (housing) or the like (not shown), a rotor 3 rotatably held on an inner peripheral side of the stator 2, and a rotor shaft 4.

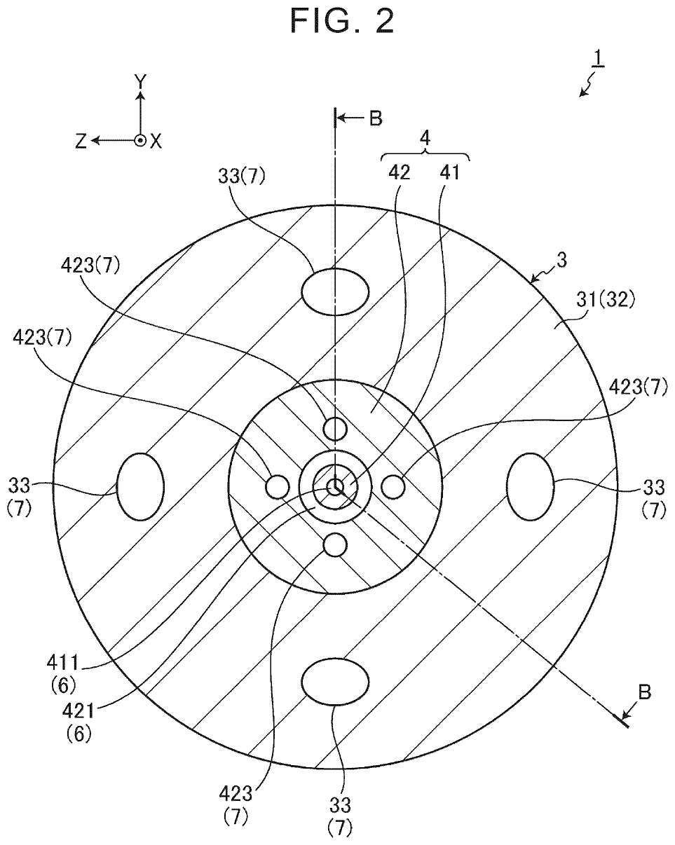

FIG. 2 is a cross-sectional arrow view of the rotor 3 and the rotor shaft 4 taken along A-A of FIG. 1. FIG. 1 is a cross-sectional view taken along B-B line of FIG. 2. In FIG. 1 and FIG. 2, the axial direction of the rotor shaft 4 is defined as the X direction, the circumferential direction orthogonal to the rotor shaft 4 is defined as the Y direction, and the depth direction orthogonal to the rotor shaft 4 is defined as the Z direction.

As shown in FIGS. 1 and 2, the stator 2 includes a stator core 21 and a stator coil 22. The stator 2 is fixed to an inner peripheral surface side of a frame (housing) (not shown).

The stator core 21 is configured by using an annular member in which a plurality of electromagnetic steel plates as a plate material made of a magnetic material are laminated. The stator core 21 is formed by setting an inner diameter so as to have an annular gap (air gap) between its inner peripheral surface and the rotor 3.

The stator coil 22 is inserted into a slot (not shown) formed in the stator core 21, and forms a magnetic pole corresponding to a current supplied from the outside. The stator coil 22 is composed of a first stator coil to which a U-phase current is supplied, a second stator coil to which a V-phase current is supplied, and a third stator coil to which a W-phase current is supplied, among three-phase alternating currents. The third stator coil is sequentially arranged in the circumferential direction of the stator core 21 from the first stator coil.

As shown in FIGS. 1 and 2, the rotor 3 is attached to the rotor shaft 4 and is configured to be rotatable about a rotation axis Xa of the rotor shaft 4. The rotor 3 includes a rotor core 31, a rotor coil 32, and a plurality of coolant channels 33.

Similarly to the stator core 21 described above, the rotor core 31 is configured by using an annular member in which a plurality of electromagnetic steel plates as a plate material made of a magnetic material are laminated. The rotor core 31 is formed by setting an outer diameter so as to have the above-described gap (air gap).

The rotor coil 32 is formed and accommodated in a slot (not shown) of the rotor core 31 by winding a coil element wire around each of a plurality of teeth (not shown) formed in the rotor core 31. In FIG. 1 and FIG. 2, only symbols are used.

The plurality of coolant channels 33 are formed in the rotor core 31 along the rotation axis Xa of the rotor shaft 4, and discharge oil OL as coolant from both ends of the rotor core 31. Here, as the oil OL, for example, ATF or the like is used. Further, the plurality of coolant channels 33 are provided at four positions at predetermined intervals, for example, at intervals of 90 degrees along the circumferential direction around the rotation axis Xa of the rotor shaft 4. Further, the plurality of coolant channels 33 are partially branched so as to be connectable to a coolant channel provided in the rotor shaft 4, which will be described later, and oil OL from the coolant channel provided in the rotor shaft 4 flows in.

As shown in FIGS. 1 and 2, the rotor shaft 4 has a fixed shaft 41 and a fixed shaft 41 in which one axial end is fixed to a case (housing) (not shown), and a rotating shaft 42 which rotates about a rotation axis Xa.

The fixed shaft 41 has a cylindrical shape (hollow portion), and has a channel 411 through which coolant Wa supplied from an external pump (not shown) flows. The fixed shaft 41 has an outer diameter smaller than an inner diameter of the rotating shaft 42 so as to have a gap (air gap).

The rotating shaft 42 is an annular rod-shaped member having an inner diameter larger than an outer diameter of the fixed shaft 41, and is rotatably supported by a support point 43 such as a bearing provided in a case (housing) (not shown). In the rotating shaft 42, the rotor 3 is attached to the outer peripheral side, the drive transmission component 5 is attached to the inner peripheral portion of the right end portion, and the rotational driving force of the rotor 3 is transmitted to the drive transmission component 5.

Further, the rotating shaft 42 is formed so that the axial lengths of the hole 421 on the inner peripheral side and the fixed shaft 41 differ so that a gap K1 is formed between the hole 421 on the inner peripheral side and the distal end of the fixed shaft 41. As a result, in the rotating shaft 42, the coolant Wa from the channel 411 of the fixed shaft 41 is discharged to the gap K1 between the fixed shaft 41 and the hole 421, and the coolant Wa flows into one axial end (left end) of the rotor shaft 4 via the hole 421. That is, the channel 411 and the channel 422 form the first coolant channel 6 that cools the motor 1 by circulating the coolant Wa supplied from the cooling pump (not shown) into the cooling pump. As the coolant Wa, for example, LLC (Long Life Coolant) or the like is used.

Further, the rotating shaft 42 has a plurality of channels 423 that are outward of the first coolant channel 6 in the rotation axis Xa and through which oil OL functioning as a coolant for cooling the motor 1 along the circumferential direction around the rotation axis Xa flows. Each of the plurality of channels 423 is provided at four positions of the rotating shaft 42 at a predetermined interval, for example, an interval of 90 degrees along the circumferential direction around the rotation axis Xa of the rotor shaft 4. Further, each of the plurality of channels 423 has a section D1 that overlaps with a portion extending along the rotation axis Xa. Specifically, each of the plurality of channels 423 partially overlaps with each other so as to surround a section D1 of a part of the first coolant channel 6 from the outer periphery along the rotation axis Xa. More specifically, each of the plurality of channels 423 is provided in the rotating shaft 42 so as to overlap with a section D1 of a part of the first coolant channel 6 along the rotation axis Xa. Further, each of the plurality of channels 423 is connected to each of the plurality of coolant channels 33 provided in the rotor core 31, and supplies oil OL from an oil pump or a drive gear (not shown) to each of the plurality of coolant channels 33. That is, the plurality of channels 423 and the plurality of coolant channels 33 provided in the rotor core 31 circulate the oil OL to form the second coolant channel 7 for cooling the motor 1.

As described above, the second coolant channel 7 and the first coolant channel 6 are formed separately along the rotation axis Xa in the rotor shaft 4. Therefore, the cooling effect can be maintained even when either the coolant Wa or the oil OL is heated. Further, the second coolant channel 7 and the first coolant channel 6 can heat-exchange the coolant Wa with the oil OL in a partial overlapping section D1 extending along the rotation axis Xa. Consequently, the motor 1 can maintain the cooling effectiveness even when either the coolant Wa or the oil OL is hot.

According to the embodiment described above, the first coolant channel 6 and the second coolant channel 7 are formed separately along the rotation axis Xa in the rotor shaft 4. Therefore, the cooling effect can be maintained even when either the coolant Wa or the oil OL is heated.

In addition, according to the embodiment, the coolant Wa and the oil OL can be heat-exchanged in the section D1 in which the second coolant channel 7 and the first coolant channel 6 partially overlap each other extending along the rotation axis Xa. Therefore, the cooling effect can be maintained even when either the coolant Wa or the oil OL is heated.

In the embodiment, the coolant Wa is circulated in the first coolant channel 6, but the type of the coolant Wa circulating in the first coolant channel 6 can be changed as appropriate, and an oil OL may be used as long as the channel is different.

In addition, in one embodiment, the rotor shaft 4 is formed separately of only the first coolant channel 6 and the second coolant channel 7, but the present disclosure is not limited thereto, and a coolant channel in which another type of coolant circulates may be further provided in the rotor shaft 4.

Additional benefits and variations can be readily derived by one of ordinary skill in the art. The broader aspects of the disclosure are not limited to the specific details and representative embodiments presented and described above. Accordingly, various modifications may be made without departing from the spirit or scope of the general inventive concept as defined by the appended claims and their equivalents.

While some of the embodiments of the present application have been described in detail with reference to the drawings, these are merely examples, and the present disclosure can be implemented in other forms in which various modifications and improvements are made based on the knowledge of a person skilled in the art, including the aspects described in the section of the disclosure of the present disclosure.

What is claimed is:

1. A motor equipped with a shaft center cooling structure, the motor comprising a rotor shaft that includes, on a shaft center, at least two kinds of coolant channels that are each configured separately along a rotation axis direction.

2. The motor according to claim 1, wherein:
in the rotor shaft, the at least two kinds of coolant channels include a first coolant channel and a second coolant channel; and
each of the first coolant channel and the second coolant channel includes a section that overlaps at a portion extending along the rotation axis direction.
